(19) United States
(12) Patent Application Publication
(10) Pub. No.: US 2010/0290613 A1
(43) Pub. Date: Nov. 18, 2010

(54) Generalized Code Communication System

(75) Inventors: Chung-Yu Tsai, Taoyuan County (TW); Pao-Ching Chen, Taoyuan County (TW); Chun-Jen Lee, Taoyuan County (TW)

Correspondence Address: SCHMEISER OLSEN & WATTS, 18 E UNIVERSITY DRIVE, SUITE # 101, MESA, AZ, 85201, US

(73) Assignee: Chunghwa Telecom Co., Ltd., Taoyuan County (TW)

(21) Appl. No.: 12/640,307

(22) Filed: Dec. 17, 2009

(30) Foreign Application Priority Data
May 18, 2009 (TW) 098116340

(51) Int. Cl. H04M 3/42

(52) U.S. Cl. 379/216.01

(57) ABSTRACT

A generalized code communication system using characters, numbers, symbols, and their combination forming a generalized code communication number as user identification for multimedia public communication service. Users use the generalized code communication system user equipment to dial numbers directly for vocal, characters, messages, images, music, and multimedia. Users also use normal cellular phone and lined telephones to send generalized code of vocal, characters, messages, images, QR codes, or other forms of data to this system to establish communication.

A generalized code communication system including user equipment comprising a device that can dial-up using generalized code function; user identification database storing registered generalized code user data and identification discriminant module identifying user equipment and number; number identification discriminant module accepting data input from non-generalized code user equipment and consult the generalized code communication user identification database to recognize the receivers generalized code communication number; an outbound adapter module to establish connection.

### BACKGROUND OF THE INVENTION

1. Field of the Invention

This invention relates to a telecommunication system being special for its generalized code communication number composes of characters, numbers, symbols, or the mixture of them as the user identification for multimedia public communication services. By dialing each other's generalized code communication number, users can use the communication services for vocals, characters, messages, images, music, multimedia, and many other ways.

2. Descriptions of the Related Art

Since Alexander Graham Bell invented the telephone, numbers are the only choice for user identification. The benefit is it is easy but it is also not intuitive for use and cannot carry too much meaning. Previous technology marks characters on top of the numbers on the number pad as 2 with ABC, 3 with DEF, 4 with GHI, and so on, to transform meaningless numbers into meaningful words. And when trying to convert a word into numbers, the result is usually incompatible. For Chinese characters and other languages not using English alphabets, the only option is to use the homophony method since number is meaningless.

For these reasons, the current practical technique is limited and is not a good solution. It needs to be improved.

Noticing the disadvantages of the current method mentioned, the inventor of this invention dedicates to improvement and invention. After years of hard working and research, this invention of generalized code communication system is successfully invented.

### SUMMARY OF THE INVENTION

The primary objective of this invention is to provide a generalized code communication number composed of characters, numbers, symbols, or their combinations for user identification in multimedia public communication service.

The second objective of this invention is to provide the choice of meaningful characters, numbers, symbols, or their combinations as user identification in telecommunication.

The further objective of this invention is to provide generalized code communication user equipments which users can use to communicate with each other in the forms of vocal, characters, messages, images, music, multimedia, and many other ways.

Yet another objective of this invention is to provide a mechanism for traditional user equipment users to dial through to the generalized code communication numbers for communications in the forms of vocal, characters, messages, images, music, multimedia, and many other ways.

The generalized code communication system that meets these objectives has:
1. Generalized code user equipment
2. Generalized code user identification database
3. Generalized code number identification discriminant module
4. Outbound adapter module

User registers the desired generalized code communication number with the generalized code user identification database to own the number. User can use generalized code user equipment to dial a generalized code communication number for connection or use a traditional user equipment to send the generalized code communication number to this generalized code communication system by vocal, image, message, or QR code. The system's generalized code number identification discriminant module identifies the transmitted number and the outbound adapter module establishes the connection for both ends.

### BRIEF DESCRIPTION OF THE DRAWINGS

Please refer to the following figures for the detail of this better practice invention for the technology and purpose. The figures include the follows:

FIG. 1. The system layout for this invention of generalized code communication system;

FIG. 2. The generalized code registration diagram for this invention of generalized code communication system;

FIG. 3. The generalized code user equipment communication diagram for this invention of generalized code communication system; and

FIG. 4. The non-generalized code user equipment communication diagram for this invention of generalized code communication system.

### DESCRIPTION OF THE PREFERRED EMBODIMENT

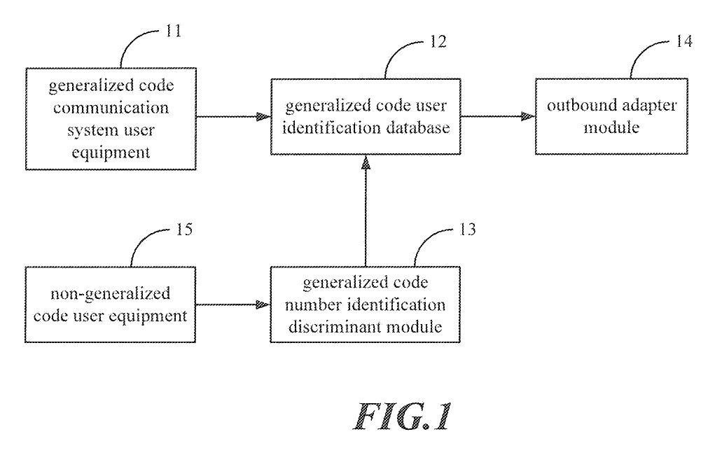

Please refer to FIG. 1 for the system layout of this invention of generalized code communication system that has:

A generalized code user equipment 11 which is a communication equipment with generalized code communication number dialing function. Generalized code communication number includes communication numbers like cellular phone numbers, land-line telephone numbers, satellite phone numbers, facsimile numbers, and pager numbers;

A generalized code number identification discriminant module 13 which can receive generalized code data from non-generalized code user equipment 15 and consult the generalized code user identification database 12 to identify the data as a receiver's generalized code communication number. This module contains one or many of the following modules: generalized code identification speech recognition module, generalized code identification image recognition module, generalized code identification character recognition module, generalized code identification message recognition module, generalized code identification QR code recognition module, generalized code identification RFID recognition module, and generalized code identification IC card recognition module;

A generalized code user identification database 12 which stores the registered user generalized code communication number data to identify generalized codes from generalized code user equipment 11 and generalized code number identification discriminant module 13 to be connected with the outbound adapter module 14; and

An outbound adapter module 14 connected to the generalized code user identification database 12 to provide and establish communication connections.

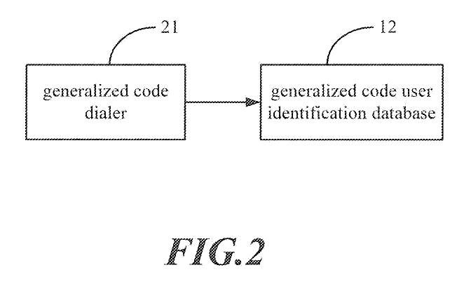

Please refer to FIG. 2 for the generalized code registration diagram for this invention of generalized code communication system showing how the user apply, register, and own the generalized code communication number. Generalized code communication user 21 applies, chooses, and registers the desired generalized code communication number to with the generalized code user identification database 12 like filing for current land-line telephone and cellular phone. The system confirms that the number was not registered before and the applicant can use the number as his own. For example, McDonalds, with the process of applying for land-line telephone or cellular phone now, registers “McDonalds” as toll-free customer service number, “I'm loving it” as advertising and promotion number, and “McDonaldsCorp” as company main number.

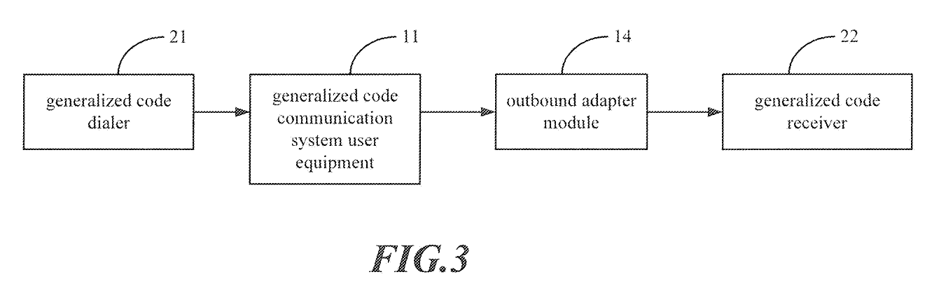

Please refer to FIG. 3 for the generalized code user equipment communication diagram for this invention of generalized code communication system. Generalized code communication system user equipments 11 are user equipments that are able to dial directly to a generalized code communication number within the service coverage area such as generalized code cellular phones and generalized code land-lined phones. Generalized code communication user 21 with generalized code communication system user equipment 11 can dial directly to the generalized code receiver 22's number. The generalized code communication system user equipment 11 first sends the receiver's number to the system, then the outbound adapter module 14 establishes the connection between generalized code communication dialer 21 and generalized code receiver 22, and the both ends can exchange vocal, character, message, image, music, multimedia data. For example, a generalized code phone user Miss Chang can use it to dial “I'm loving it” for McDonalds' latest promotion.

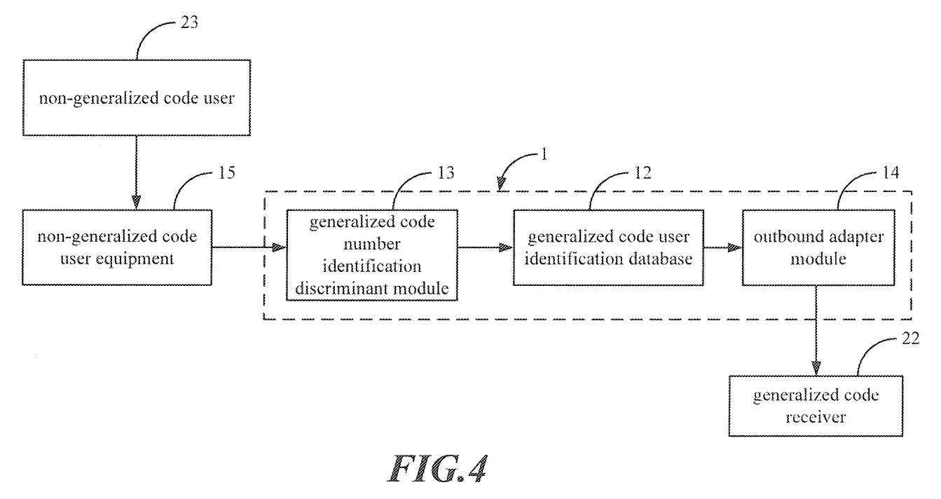

Please refer to FIG. 4 for the non-generalized code user equipment communication diagram for this invention of generalized code communication system. Non-generalized code user 23 uses non-generalized code user equipment 15 to send the generalized code number via vocal, character, message, image, QR code or other data format to the generalized code number identification discriminant module on this generalized code communication system 1. The generalized code number identification discriminant module 13 receives the data from non-generalized code user 23, consults with the generalized code user identification database 12 for the receiver's generalized code number, then the outbound adapter module 14 establishes the communication connection between non-generalized code user 23 and generalized code receiver 22 so they can perform vocal, character, message, image, music, multimedia data transmission. For example, a regular land-lined phone user Mr. Lee sends generalized code “McDonalds” to the system by voice, the system receives the voice input and recognizes its generalized code “McDonalds”, and then the outbound adapter module connects Mr. Lee with McDonalds' toll-free customer service.

This invention of generalized code communication system has these benefits:
1. Without the limitation of number-only, user can have a generalized code communication number with number, character, and symbol or the combination as his user identity in multimedia public communication service.
2. Institutions and companies can use their name as the generalized code communication number so the customers don't have to remember another number and improve the communication.
3. Commercial users can use generalized code number for advertising and promotion.

The aforementioned descriptions are solely for explaining the embodiments of the present invention and are not intended to limit the scope of the present invention. Any equivalent practice of modification within the spirit of the present invention should be treated as being within the scope of patent of the present invention.

As aforementioned, the present invention is novel in technology and advantaged in many effects that the prior arts lack. The present invention conforms to the novelty and non-obviousness of patentability. Please the examiner carefully considering the application of the present invention and allowing the application.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A generalized code communication system comprising:
a generalized code user equipment that dials directly to a generalized code number with the service coverage area;
a generalized code user identification database; that accepts data sent by non-generalized code user equipment, consults the generalized code user identification database, and recognizes the content as generalized code receiver's generalized code communication number;
the generalized code user identification database that storing the registered generalized code communication user data and recognizing generalized code from generalized code user equipment and the generalized code number identification discriminant module; and
an outbound adapter module connected to the generalized code user identification database to provide and establish communication connections.

2. The generalized code communication system as claimed in claim 1, the generalized code number identification discriminant module being selected from groups of generalized code identification speech recognition module, generalized code identification image recognition module, generalized code identification character recognition module, generalized code identification message recognition module, generalized code identification QR code recognition module, generalized code identification RFID recognition module, and generalized code identification IC card recognition module.

3. The generalized code communication system as claimed in claim 1, the generalized code including communication numbers composed of character, number, symbol and combinations thereof as the user identity in multimedia public telecommunication.

4. The generalized code communication system as claimed in claim 1, the generalized code communication number being selected from groups of any kind of communication numbers like cellular phone numbers, land-line telephone numbers, satellite phone numbers, facsimile numbers, and pager numbers.

5. The generalized code communication system as claimed in claim 1, the non-generalized code user using non-generalized code user equipment to send the generalized code number via vocal, character, message, image, QR code or other data format to the generalized code number identification discriminant module on this generalized code communication system.
